(19) United States
(12) Patent Application Publication
(10) Pub. No.: US 2012/0192070 A1
(43) Pub. Date: Jul. 26, 2012

(54) INTERACTIVE SOUND SYSTEM

(76) Inventors: Manuel Dias Lima de Faria, Lisboa (PT); Luis Filipe Veigas, Costa da Caparica (PT); João Manuel de Castro Afonso, Cascais (PT)

(21) Appl. No.: 13/355,079

(22) Filed: Jan. 20, 2012

Related U.S. Application Data
(60) Provisional application No. 61/434,965, filed on Jan. 21, 2011.

(51) Int. Cl. G06F 3/01; H04R 5/02

(52) U.S. Cl. 715/716

(57) ABSTRACT

An interactive sound system is provided. The interactive sound system includes a plurality of sound channels arranged in a hierarchy, a representation of real space, a visual arrangement of the plurality of sound channels over the representation of real space, a user interface for simultaneous management of more than one sound channel in parallel, and a processing module. The processing module is configured to apply a user-attributed behavior to a sound channel over a hierarchically transmitted behavior, automatically assign a behavior to a sound channel following the activation of an automatic trigger, accept a manual assignment of a behavior to a sound channel following the activation of a human-operated trigger, and override a sound channel with an alarm behavior.

### CROSS-REFERENCE TO RELATED APPLICATIONS

This application claims priority to U.S. Provisional Patent Application No. 61/434,965 filed Jan. 21, 2011, the contents of which is incorporated herein by reference in its entirety.

### TECHNICAL FIELD

The present disclosure is generically in the field of sound processing.

### BACKGROUND

Sound management systems are comprised in prior art. In particular:

U.S. Pat. No. 7,448,057 “Audiovisual reproduction system” describes a system in which the volume of sound is adjustable per separate areas.

WO200209159 “DIGITAL MULTI-ROOM, MULTI-SOURCE ENTERTAINMENT AND COMMUNICATIONS NETWORK” describes a network of peer-to-peer units that can alternate between a predefined set of playlists.

The present disclosure is of a system that encompasses the areal adjustment of sound, but in which such adjustment is also subject to hierarchical rules.

Playlists are also a part of the disclosed system, but their selection is not operated by peer-to-peer units, rather by a central control system.

Further to these elemental differences, the system presently disclosed is of greater complexity than the systems described in the above referenced patent documents, incorporating elements not found therein, which are described below.

### BRIEF DESCRIPTION OF THE DRAWINGS

FIG. 1 is a schematics of components for a computer system and associated peripheral that embody an aspect of this disclosure.

FIG. 2 is a schematics of components for a computer system that embodies an aspect of this disclosure.

FIG. 3 is a diagram of sound zones.

FIG. 4 is a diagram of sound zones and of a user action bar.

### DESCRIPTION

This disclosure is of a system comprised of a software application that relies on specific hardware to manage sound over multiple zones.

In an exemplary embodiment, a computer runs a software application that allows for the definition of sound over also definable zones.

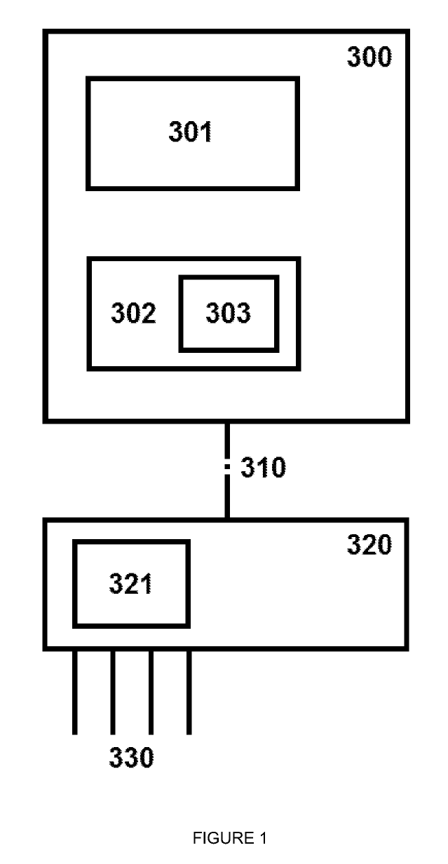

FIG. 1 is a partial diagram of a computer embodying the present disclosure, wherein the computer 300 incorporates a processor 301 for running the software application, memory 302 for storing the software application 303, means for a user to control the software application, which can be partly consistent of visualization means, and means 320 for distributing a sound signal by multiple channels.

Processor 301 can be one or more of any kind of processor that can run the software application, over a general-purpose operating system or not, including a CISC processor, such as an x86 processor, or a RISC processor, such as a SPARC or an ARM processor.

Memory 302 can be any kind of memory, including ROM, EPROM and EEPROM.

The means for a user to control the software application can be any control means that are recognizable by the computer, including, concurrently or alternatively:
a keyboard;
a mouse;
a sensing surface; and/or
a depth-sensing camera.

A user can interface with the computer through a touchscreen physically connected to the computer. Another user-computer interface can be a 3D display, wherein the user directly touches the 3D display on action areas.

The software application can also be controlled by a handheld device which has a wireless communication protocol, e.g. Wi-Fi, active between itself and the computer. The handheld device may be a simple control device with wireless communication means, or it may be a separate device that runs a software application client to the server software application of the computer.

Moreover, the software application running on the computer can be remotely controlled by another device capable of running a client application and that is connected to the computer by a communications protocol such as Transmission Control Protocol-Internet Protocol (TCP-IP).

The means for distributing a sound signal by multiple channels 330 can be an external audio interface 320, which can have more than one separate component, including a Digital to Analog Converter (DAC) 321, or can be embodied in a single multichannel DAC. The external audio interface communicates with computer 300 through communication means 310.

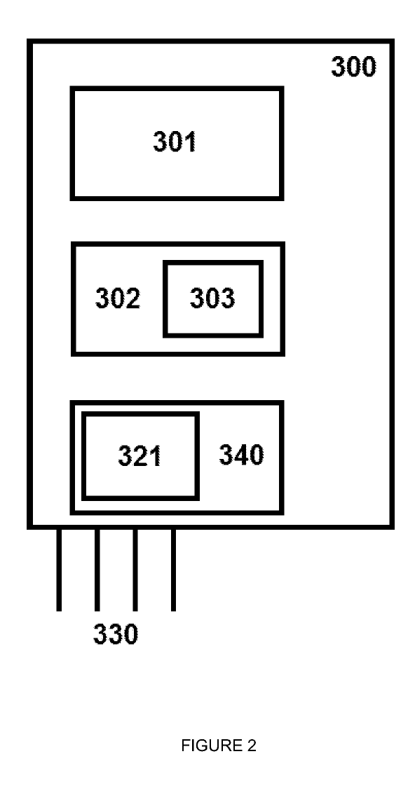

FIG. 2 shows a soundboard 340, which is an alternative to the external audio interface and contains at least a DAC 321, integrated into computer 300.

A simple embodiment of multichannel distribution can be to assign one speaker to each single sound channel, but this can easily be tweaked through intermediate devices which fall outside of the purpose of this disclosure.

The software application is configured to allow the user to control sound over multiple channels.

The software application has a Graphical User Interface (GUI) through which the user controls the sound channels. The GUI displays a representation of zones, which can be a scale representation of a physical space, or a metaphoric representation of a physical space.

For a scale representation of a physical space, a user may draw a simple layout thereby defining zones, or the user may use a previously generated image of a physical space, such as an architectural plant as reference, as a blueprint for drawing zones.

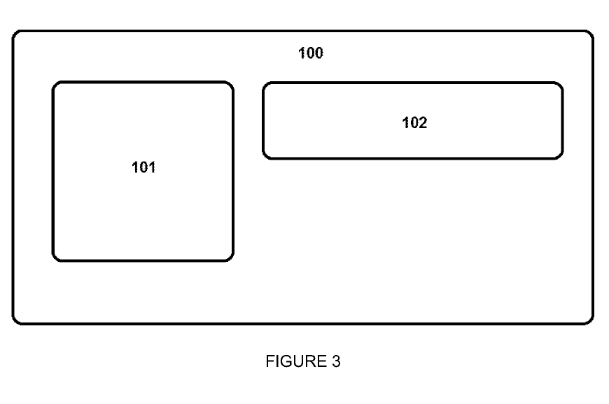

FIG. 3 displays a zone 100, with lower level zones 101 and 102 which can be drawn by a user of the system with full editing privileges—the user would first draw zone 100, and then zones 101 and 102 inside.

A user with full editing privileges can operate the software application to:
distribute the sound channels through the zones;
create playlists;
create behaviors; and
assign behaviors to zones.

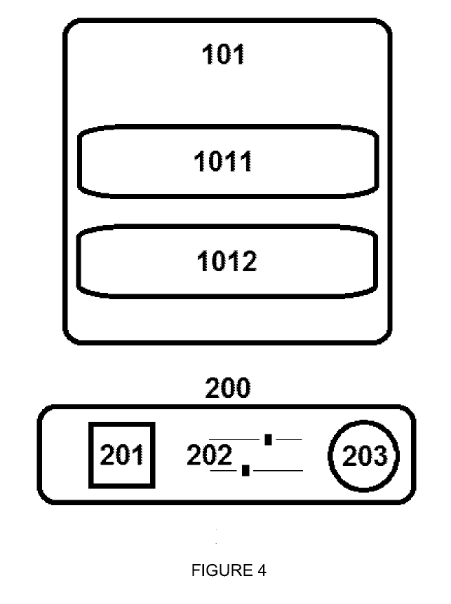

FIG. 4 shows a further element to the GUI, a user action bar 200, of type that would be attributed to a user with limited privileges. It has buttons 201 and 203, that while pressed may, for instance, activate a microphone 201 and a stop button 203. Microphone button 201 may serve to activate a microphone so that the user may talk into the selected zone. Stop button 203 may serve to mute all sound in all or the selected zones so that the user can be heard more clearly when talking on the microphone, or upon the activation of an automatic emergency procedure.

Volume sliders 202 may affect the sound volume in the selected zone and the volume of the microphone, so that the user can adjust sound in a zone if there is the perception of a momentarily inadequate volume.

A user with limited privileges can operate the software application to:
change the sound volume in a zone;
monitor a zone;
use the microphone; and
activate emergency procedures.

The software application may be recorded on a tangible data carrier.

Zones are a key concept to this disclosure: a zone is a hierarchical, multi-level element, comprising one or more lower-level zones at all levels except the lowest, where it consists solely of itself.

In a preferred embodiment to this disclosure, at any time there are visible just 2 levels of zones: a zone of a certain level and its contained zones of the immediately lower level, if any.

FIG. 3 shows an embodiment of the GUI for the software application, where a higher level zone 100 contains 2 lower-level zones, 101 and 102. These zones can be, for instance, a level of a building, in which zone 100 represents the entire level, whilst zones 101 and 102 represent specific rooms in that level.

For a metaphoric representation of a physical space, a user may define zones and arrange them in free form, such as by grouping them into higher-level zones.

Behaviors can be associated with zones through the software application, and are limited only to the software application's own limitations. Playlists are important elements of behaviors, which can control playlists by playing them, halting them, varying their volume of sound, modulating their sound, or spatializing their sound over one or more zones.

Sequentially playing a playlist with no added features or logic is the simplest kind of behavior.

When a behavior is defined for a zone, it cascades to all lower level zones. As a general rule, a zone accepts a behavior cascading from a higher level zone unless it was directly assigned a behavior itself. As a special case, a behavior of alarm for a zone overrides all behaviors within that zone and contained lower-level zones. These rules can be abstracted by assigning a priority level assigned to each behavior.

Behaviors can be composed of different elements. In a preferential embodiment, at the level of the software application, a behavior consists of 3 files:
an Extensible Markup Language (XML) file, holding metadata such as tags;
a library file, such as a Dynamic Link Library (DLL) file, which defines what the behavior does;
a Small Web Format file (SWF; previously know as a ShockWave Flash file), which defines how the library file is applied.

As a concrete example, a behavior to be applied to a zone may have as files:
an XML with content ‘intro’, ‘sampling’, ‘130 bpm’;
a library file that is operable to play the first 10 seconds of every file of a playlist counting from the beginning of the sound wave on each file;
a SWF file in which each sequential file is played through a single sound channel that is different from the channel of the previous file.

Behaviors can be defined to be standardly active in a zone, or to be activated in response to a trigger, as detailed below. Spatialization is another important element of behaviors. Examples of spatialization can be:
to continuously change the volume of the sound channels for an area to create the impression that a playlist is moving around the zone;
use of a depth-sensing camera as a zone sensor, so that the front plane of the body of a human visitor is inferred, and then used in the spatial model of the application so that a sound is produced consistently behind the human participant;
use of a depth-sensing camera as a zone sensor, so that a same playlist follows a specific visitor around in all zones that the visitor visits; and
alternatively, by using a microphone as a zone sensor, the software application may use voice for the same effect as the 3D data above.

Triggers are another layer of interactivity in the system. A trigger in place as part of the behavior of a zone implies that at least part of the behavior will only be active when the trigger is activated.

As examples, a trigger can be any or a combination of:
a motion detector, that triggers a playlist specific to a zone to be played for the duration of time that the motion detector detects motion;
a specific time of the day, triggering a specific playlist, or an alteration in sound, such as in volume, pitch or tempo, of the list within the time frame is altered;
the presence of a certain user, which can cause a behavior to be activated in the zone of the user or in a different zone;
a luminosity sensor outside walls, that conditions behaviors so that only behaviors with playlists above a certain tempo and pitch are played in one or more zones when the luminosity is above a defined threshold.

The above are automatic triggers. Triggers can also be manual, voluntarily activated by a visitor, such as a switch labeled ‘more magic’ in a zone, that when flicked by a visitor in the zone triggers a random behavior in a random zone.

The presently disclosed invention may be further understood through reference to the attached Appendix A.

The disclosed embodiments vie to describe aspects of the disclosure in detail.

Other aspects may be apparent to those skilled in the state-of-the-art that, whilst differing from the disclosed embodiments in detail, do not depart from this disclosure in spirit and scope.

1. An interactive sound system, comprising:
a plurality of sound channels arranged in a hierarchy;
a representation of real space;
a visual arrangement of the plurality of sound channels over the representation of real space;
a user interface for simultaneous management of more than one sound channel in parallel;
a processing module configured to:
apply a user-attributed behavior to a sound channel over a hierarchically transmitted behavior;
automatically assign a behavior to a sound channel following the activation of an automatic trigger;
accept a manual assignment of a behavior to a sound channel following the activation of a human-operated trigger; and
override a sound channel with an alarm behavior.

2. The system of claim 1, wherein the user-attributed behavior is playing tracks from a playlist.

3. The system of claim 1, wherein the user-attributed behavior is the spatialization of sound.

4. A computer system for processing audio, comprising:
a processor;
a memory coupled to the processor;
a software application stored in the memory to be executed on the processor;
a sound generator controlled by the software application and configured to output audible waveforms;
a user input for specifying a behavior of the software application; and
a graphical user interface for displaying a visual a representation of the behavior of the sound generator.

5. The computer system of claim 4, wherein the software application is configured to:
visually arrange more than one sound channel over a representation of real space;
simultaneously manage more than one sound channel in parallel;
arrange more than one sound channel in a hierarchy;
enforce a user-attributed behavior to a sound channel over a hierarchically transmitted behavior;
automatically assign a behavior to a sound channel following the activation of an automatic trigger;
manually assign a behavior to a sound channel following the activation of a human-operated trigger; and
override a sound channel with an alarm behavior.

6. The computer system of claim 4, wherein the sound generator is configured to:
receive sound in digital format from the memory;
transform the digital format from digital to analog; and
divide the sound into separate sound channels.

7. The computer system of claim 4, wherein the user-input comprises a touchscreen interface.

8. The computer system of claim 4, wherein the graphical user interface and user input are remote from the processor executing the software application.

9. The computer system of claim 8, wherein graphical user interface and user input communicates with the processor executing the software application via the Transmission Control Protocol-Internet Protocol.

10. A tangible computer readable media comprising software instructions that, when executed on a computer, are configured to:
visually arrange more than one sound channel over a representation of real space;
simultaneously manage more than one sound channel in parallel;
arrange more than one sound channels in a hierarchy;
enforce a user-attributed behavior to a sound channel over a hierarchically transmitted behavior;
automatically assign a behavior to a sound channel following the activation of an automatic trigger;
manually assign a behavior to a sound channel following the activation of a human-operated trigger; and
override a sound channel with an alarm behavior.
